(19) United States
(12) Patent Application Publication
(10) Pub. No.: US 2026/0110884 A1
(43) Pub. Date: Apr. 23, 2026

(54) LIGHT DETECTION AND NOTIFICATION DEVICE FOR A MOBILE PHONE

(71) Applicant: Raedine Bridge, Sharpsville, PA (US)

(72) Inventor: Raedine Bridge, Sharpsville, PA (US)

(21) Appl. No.: 19/348,143

(22) Filed: Oct. 2, 2025

Related U.S. Application Data
(60) Provisional application No. 63/710,171, filed on Oct. 22, 2024.

(51) Int. Cl. G02B 13/00; G02B 7/02; G06F 3/16; H04M 1/02

(52) U.S. Cl. CPC G02B 13/0075; G02B 7/023; G06F 3/167; H04M 1/0254

(57) ABSTRACT

A light detection assembly for a cell phone to aid visually impaired individuals in determining operational status of appliances. The light detection assembly is a combination of an existing phone app that detects light and provides an audible sound and an attachment over the camera lens of the cell phone restricting the field of view thereto when placed on an appliance indicator light.

This application claims the benefit of U.S. Provisional Application No. 63/710,171 filed on Oct. 22, 2024.

### BACKGROUND OF THE INVENTION

### 1. Technical Field

This invention relates to devices to aid visually impaired individuals to improve their daily life by providing an audio indication of status lights and indicators on every day household appliances.

### 2. Description of Prior Art

Prior art devices for cell phone attachments are typically directed towards lens supplement which are secured to the cell phone for a variety of different optical enhancements, see for example U.S. Pat. No. 8,593,745 and International Patent WO2015/003321.

U.S. Pat. No. 8,593,745 discloses a camera lens communication device that is attached to a cell phone overlying the lens.

International Patent WO2015/003321 is directed to a mobile phone lens amplifier including a telescopic lens and lens cone and sleeve.

Other prior art devices, see for example, U.S. Publication 2016/0267813 is directed to detection systems for visually impaired individuals having a set of light sensitive sensors on a finger cover allowing the user to place their finger on a surface and then through biometric feedback determine its availability to light and color.

In U.S. Publication 2015/0062291 a communication device that has an apertured device to reflect light into the lens for a panoramic view is disclosed.

### SUMMARY OF THE INVENTION

A light detection and notification apparatus that is attached over the camera lens of a mobile phone that physically limits it field of view by providing a reduced light access to the lens from a specific source thereby affording direct contact with the light source to determine if illumination is occurring. This allows visually impaired individuals to tell a light on an appliance is illuminated indicating its status by generating an audio signal in response to the presence of light.

### DESCRIPTION OF THE DRAWINGS

FIG. 1 is an enlarged side elevational view of the signal light detection and notification device of the invention.

FIG. 2 is an end view thereof on lines 2-2 of FIG. 1.

FIG. 3 is a perspective view thereof.

FIG. 4 is a perspective view of the light detection device as to be positioned on a mobile phone.

FIG. 5 is a perspective view of the mobile phone with the light device positioned thereon.

FIG. 6 is a side elevational view thereof in use on an appliance having status lights onto which the device can be physically positioned for indication of illumination.

FIG. 7 is a perspective view of an alternate form of the invention on a mobile phone.

FIG. 8 is an enlarged partial side elevational view thereof showing the device in stored position and in broken lines in extended use position.

FIG. 9 is an enlarged front elevational view of the alternate form of the invention showing the adaptability for repositioning on two axis.

### DETAILED DESCRIPTION OF THE INVENTION

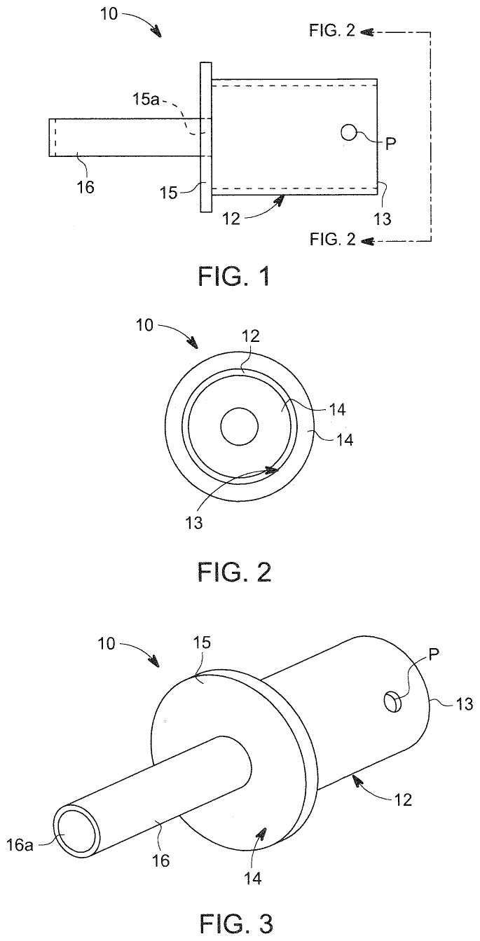

Referring to FIGS. 1-6 of the drawings, a status light detection device 10 of the invention can be seen having a cylindrical main body member 11 with a tubular lens engagement portion 12 with an open end 13, best seen in FIGS. 1 and 2 of the drawings. A transition support 14 is secured in oppositely disposed relation to the open end 13 and is comprised of an annular disk 15 of increased diameter to that of tubular lens engagement portion 12 on which it is engaged.

The disk 15 has a center opening at 15A with an appliance engagement signal light tube 16 extending therefrom and is of a length, in this example, equal to that of the known length of the hereinbefore described lens engagement portion 12.

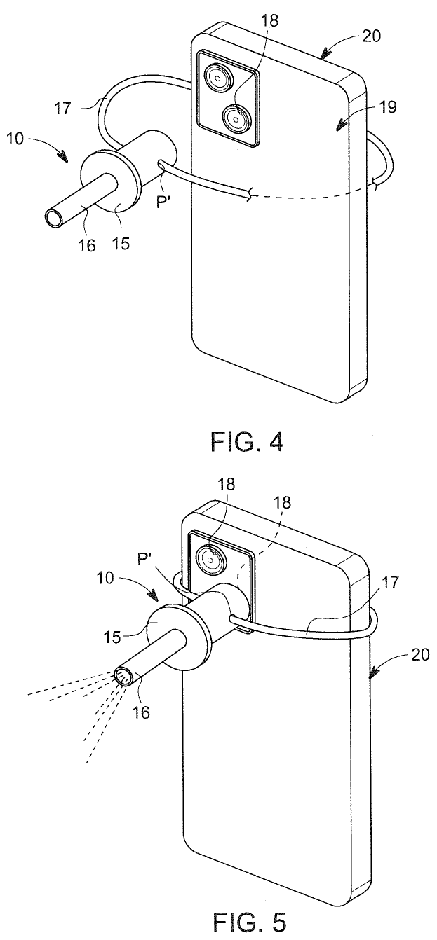

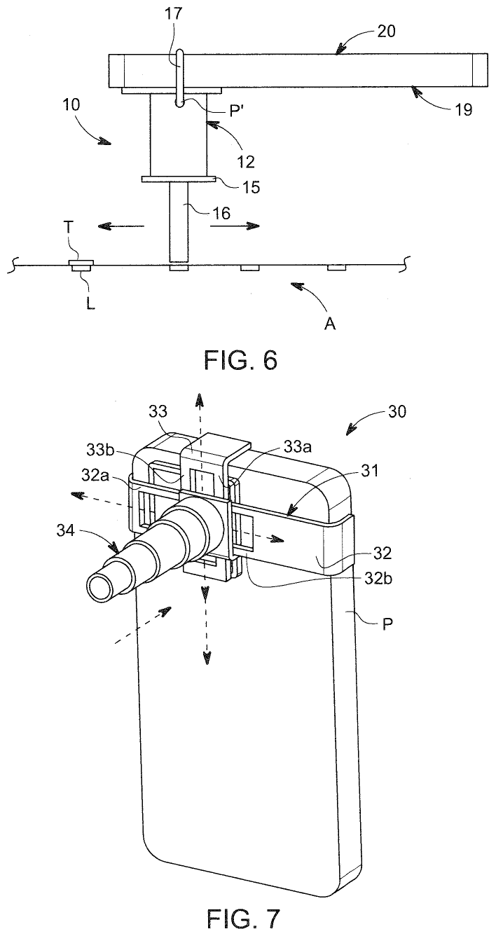

A resilient retaining band 17 extends from an attachment point P on the lens engagement portion 12 spaced inwardly from its free open end 13 to an oppositely disposed attached point P′ in transverse relation thereto, as best seen in FIG. 4 of the drawings. The resilient band 17 extends around a typical smart mobile phone 18 so that the lens engagement tube 12 overlies the phone camera lens 18 on the backside 19 of the phone 20 display screen as seen in FIGS. 5 and 6 of the drawings.

It will be evident from the above description that the light detection device 10 can therefore be easily adapted to a variety of mobile phones having a camera.

In operation, the so attached signal light detection device 10 will therefore reduce the effective light gathering field of the phone's camera lens 18 limiting it to the reduced opening at 16A in the free end thereof. The mobile phone 20 is equipped with a commercially available light detection app that uses the phone's camera to detect light and generate an audio indication thereof telling the visually impaired individual that an appliance A status light L is activated and a light is present. By using the status light detector 10, the visually impaired user, not shown, can by touch place the so equipped phone 20 over an indicator light L on the appliance A as seen graphically in FIG. 6 of the drawings and by using the light detection app be notified when the light is illuminated indicating the status of the appliance onto which it is engaged.

This will provide an auditory alert allowing the user to determine the status of the appliance or during selection of use, for example, in a washing machine cycle determination.

It may be necessary to provide the appliance lights L with a raised tactile surface indicators T to assist in the visually impaired users positioning so the equipped phone can be guided and engaged over the light to be detected.

Referring now to FIGS. 7-9 of the drawings, an alternate adjustable and collapsible light detection device 30 of the invention can be seen having a dual bracket track assembly 31 selectively engaged on a mobile phone P. The dual bracket track assembly 31 has pairs of guide tracks 32 and 33 with a telescopically collapsible phone lens engagement element 34 slidably positioned thereon.

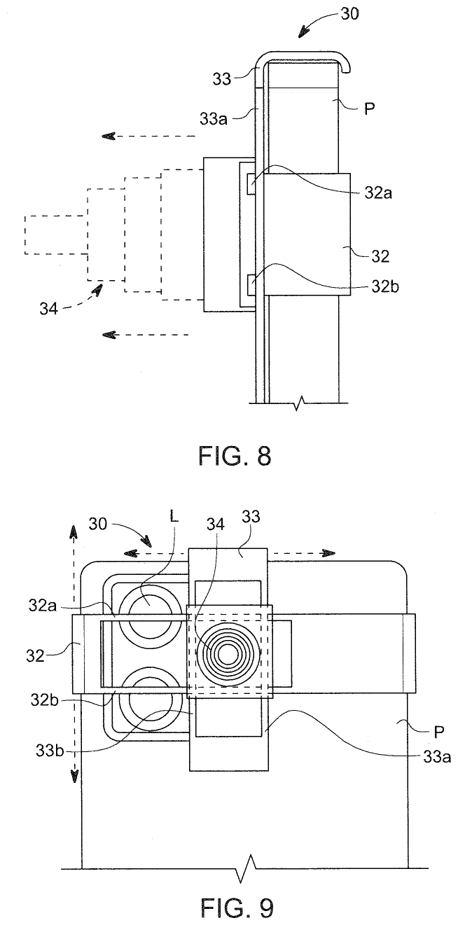

Each of the tracks 32 and 33 have a pair of spaced parallel guide rails 32A and 32B and 33A and 33B to allow the collapsible phone lens engagement element 34 to be slidably positioned thereon. This orientation allows two axis of the engagement element 34 indicated by broken lines along the respective rail pairs. The engagement element 34 has a plurality of interlocking rings that are of varied sizes to allow for conical extension to full open position, seen graphically in FIG. 7 of the drawings and in broken lines in FIG. 8 of the drawings. Correspondingly, the engagement element 34 can collapse into itself as seen in FIG. 8 of the drawings so that it may remain attached to the phone in certain application situations.

As noted, the track pairs 32A and 32B allow for select adjustment as needed and it will be evident from the above description that the alternate engagement element 34 can be easily positioned over each individual lens L, as needed, providing a reduced field of vision for engagement of the light detection app, previously described and disclosed.

It will thus be seen that a new and novel light detection and notification device for a mobile phone has been illustrated and described and it will be apparent to those skilled in the art that various changes and modifications may be made therein without departing from the spirit of the invention. Therefore, I claim:

1. An equipment status light detection device for a mobile phone camera comprises,
a camera lens engagement cylinder having an open-ended signal light tube in communication therewith,
a transition support between said camera lens engagement cylinder and said signal light tube,
said signal light tube is of a diameter less than that of said camera lens engagement cylinder restricting the optical field of view of said camera lens when engaged on an equipment status light.

2. The equipment status light detection device set forth in claim 1 wherein said camera lens cylinder has retainment bands for securing said engagement cylinder to a mobile phone.

3. The equipment status light detection device set forth in claim 1 wherein said camera lens engagement cylinder is slidably disposed over said camera lens on vertical and horizontal axis.

4. The equipment status light detection device set forth in claim 1 wherein said transitional support comprises,
a telescopically adjustable camera lens engagement element.

5. The equipment status light detection device set forth in claim 1 wherein said mobile phone has a light detection app to indicate the presence of light within the optical field of view.

6. The equipment status light detection device set forth in claim 1 wherein said equipment status light comprises, equipment cycle determination illumination.

7. The equipment status light detection device set forth in claim 3 wherein said camera lens engagement cylinder is slidably disposed in vertical and horizontal axis comprises,
a pair of overlying guide tracks on said mobile phone.

8. The equipment status light detection device set forth in claim 5 wherein said camera engagement cylinder guide tracks comprises, pairs of spaced parallel guide rods.

9. The equipment status light detection device set forth in claim 5 wherein said light detection app provides an audio indication when light is detected by said mobile phone camera.
